(19) United States
(12) Patent Application Publication
(10) Pub. No.: US 2026/0192347 A1
(43) Pub. Date: Jul. 9, 2026

(54) Electrode Rolling Apparatus and Control Method Thereof

(71) Applicant: SK On Co., Ltd., Seoul (KR)

(72) Inventors: Hui Seon JANG, Daejeon (KR); Ji Tae PARK, Daejeon (KR); Min Ki LEE, Daejeon (KR); Ye Chan LEE, Daejeon (KR); Yun Seok JANG, Daejeon (KR)

(21) Appl. No.: 19/439,683

(22) Filed: Jan. 5, 2026

(30) Foreign Application Priority Data
Jan. 8, 2025 (KR) 10-2025-0002893

(51) Int. Cl. B21B 37/58; B21B 1/24; H01M 4/04

(52) U.S. Cl. CPC B21B 37/58; B21B 1/24; H01M 4/0435; B21B 2269/00

(57) ABSTRACT

Proposed are an electrode rolling apparatus and a control method of the electrode rolling apparatus. The electrode rolling apparatus comprises an upper roller, a lower roller spaced apart from the upper roller by a predetermined distance, a roller driving unit configured to rotate the upper roller and the lower roller and to adjust a gap between the upper roller and the lower roller, and a controller configured to control the roller driving unit such that the gap between the upper roller and the lower roller is increased up to an opening gap when a rolling process in which an electrode moving in one direction is rolled by passing between the upper roller and the lower roller is temporarily stopped.

### CROSS REFERENCE TO RELATED APPLICATION

The present application claims priority to Korean Patent Application No. 10-2025-0002893, filed Jan. 8, 2025, the entire contents of which are incorporated herein for all purposes by this reference.

### TECHNICAL FIELD

The present disclosure relates to an electrode rolling apparatus and a control method of the electrode rolling apparatus.

### BACKGROUND

A secondary battery is a battery capable of being charged and discharged. The secondary battery is widely used in an electric vehicle, an Energy Storage System (ESS), and a portable electronic device. The secondary cell battery is formed of a cell in which each electrode (a positive electrode and a negative electrode), a separator, and an electrolyte are stored in a casing. The electrode may be manufactured through a process of coating an active material on a current collector, a process of drying the active material, a process of rolling the active material, and a process of forming and cutting a tab. A process of rolling the electrode may increase the contact between the active material and the current collector. When the rolling process is performed, the volume of the active material in the electrode is reduced, so that the energy density of the battery cell may be increased. In the rolling process, an apparatus configured to press both sides of the electrode by using a rotating roller may be used.

### SUMMARY

According to an aspect of the present disclosure, there is provided an electrode rolling apparatus and a control method of the electrode rolling apparatus configured to prevent an over-rolling phenomenon by increasing a gap between rollers when a process of rolling an electrode is temporarily stopped.

According to an aspect of the present disclosure, there is provided an electrode rolling apparatus and a control method of the electrode rolling apparatus configured to predict an appropriate gap between rollers and a starting time for adjusting the gap according to a specification of a process of rolling an electrode.

The electrode rolling apparatus and the control method of the electrode rolling apparatus according to an aspect of the present disclosure may be applied to a manufacturing process of a battery widely used in green technology fields such as electric vehicles, battery charging stations, and other fields using a battery, such as the solar photovoltaic power generation field, the wind power generation field, and so on.

The electrode rolling apparatus and the control method of the electrode rolling apparatus according to an aspect of the present disclosure may be applied to a manufacturing process of a battery used in an eco-friendly electric vehicle, a hybrid vehicle, and so on for preventing climate change by suppressing air pollution and the emission of greenhouse gases.

According to an aspect of the present disclosure, there is provided an electrode rolling apparatus comprising: an upper roller; a lower roller spaced apart from the upper roller by a predetermined distance; a roller driving unit configured to rotate the upper roller and the lower roller and to adjust a gap between the upper roller and the lower roller; and a controller configured to control the roller driving unit such that the gap between the upper roller and the lower roller is increased up to an opening gap when a rolling process in which an electrode moving in one direction is rolled by passing between the upper roller and the lower roller is temporarily stopped.

According to an aspect of the present disclosure, when the rolling process is temporarily stopped, the controller may be configured to control the roller driving unit such that the gap between the upper roller and the lower roller is increased from an opening time that is a time point at which a moving speed of the electrode is decreased to a predetermined speed.

According to an aspect of the present disclosure, when the rolling process is temporarily stopped, the controller may be configured to control the roller driving unit such that the gap between the upper roller and the lower roller is increased at a roller moving speed at which the upper roller and the lower roller are moved away from each other.

According to an aspect of the present disclosure, the controller may be configured to control the roller driving unit so as to increase the gap between the upper roller and the lower roller by moving only one of the upper roller or the lower roller or by moving both the upper roller and the lower roller.

According to an aspect of the present disclosure, the controller may be configured to provide a setting interface for receiving input values of an opening time at which the upper roller and the lower roller start to be moved away from each other and the opening gap at which the upper roller and the lower roller are moved away from each other.

According to an aspect of the present disclosure, the controller may be configured to provide a prediction interface configured to predict a thickness of the electrode in a stop-rolling section by using a prediction model when the opening gap and the opening time are input to the prediction interface, the prediction model being generated by training, through a regression modeling method, training data collected while the rolling process is performed on the electrode and then the rolling process is temporarily stopped, in which the training data uses a thickness of the electrode in a pre-stop rolling section, the opening gap, and the opening time as independent variables and uses the thickness of the electrode in the stop-rolling section as a dependent variable.

According to an aspect of the present disclosure, when the opening gap and the opening time are input and a prediction button is selected through the prediction interface, the prediction interface may be configured to display a graph indicating whether a predicted thickness of the electrode in the stop-rolling section is outside a normal range for each predetermined candidate value comprised in an allowable range of the thickness of the electrode in the pre-stop rolling section.

According to an aspect of the present disclosure, there is provided a control method of an electrode rolling apparatus, the control method comprising: rolling an electrode by using an upper roller and a lower roller, and controlling, by a controller, a roller driving unit configured to operate the upper roller and the lower roller such that a gap between the upper roller and the lower roller is increased up to an opening gap when the rolling of the electrode is temporarily stopped.

According to an aspect of the present disclosure, the control method may further comprise re-controlling, by the controller, the roller driving unit operating the upper roller and the lower roller such that the gap between the upper roller and the lower roller is decreased up to a production gap when the temporary stop of the rolling of the electrode is released.

According to an aspect of the present disclosure, in the controlling of the roller driving unit, the controller may control the roller driving unit such that the upper roller and the lower roller are moved away from each other at a predetermined roller moving speed from an opening time at which a moving speed of the electrode reaches a predetermined speed.

According to an aspect of the present disclosure, the control method may further comprise receiving, by the controller through a setting interface, input values of an opening time at which the upper roller and the lower roller start to be moved away from each other and the opening gap at which the upper roller and the lower roller are moved away from each other.

According to an aspect of the present disclosure, the control method may further comprise: providing, by the controller, a prediction interface configured to predict a thickness of the electrode in a stop-rolling section by using a prediction model when the opening gap and a speed at the opening time are input to the prediction interface, the prediction model being generated by training, through a regression modeling method, training data collected while the rolling of the electrode is performed and then the rolling of the electrode is temporarily stopped, in which the training data uses a thickness of the electrode in a pre-stop rolling section, the opening gap, and a roller moving speed as independent variables and uses the thickness of the electrode in the stop-rolling section as a dependent variable; and inputting, by the controller, the opening gap and the opening time that are input through the prediction interface to the prediction model and displaying the thickness of the electrode in the stop-rolling section predicted by the prediction model.

According to an aspect of the present disclosure, in the displaying of the predicted thickness of the electrode in the stop-rolling section, the predicted thickness of the electrode in the stop-rolling section may be further displayed as a graph for a plurality of sensing points arranged along a width direction of the electrode, and a determination result indicating whether the predicted thickness of the electrode in the stop-rolling section deviates from a normal range may be further displayed.

The features and advantages of the present disclosure will be more clearly understood from the following detailed description based on the accompanying drawings.

The terms and words used in the present specification and claims should not be interpreted as being limited to typical meanings and dictionary definitions, but should be interpreted as having meanings and concepts relevant to the technical scope of the present disclosure based on the rule according to which an inventor can appropriately define the concept of the term to describe most appropriately the best method he or she knows for carrying out the present disclosure.

According to an embodiment of the present disclosure, when the process of rolling the electrode is temporarily stopped, the over-rolling phenomenon of the electrode positioned between the rollers may be prevented.

According to an embodiment of the present disclosure, the appropriate gap between the rollers and the starting time for adjusting the gap according to the specification of the process of rolling an electrode may be predicted.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating an electrode rolling apparatus according to an embodiment;

FIG. 2 is a block diagram illustrating the electrode rolling apparatus according to an embodiment;

FIG. 3 is a view illustrating a portion of a rolled electrode according to an embodiment;

FIG. 4 is a graph showing a thickness of the rolled electrode according to an embodiment;

FIG. 5 is a view illustrating an operation of rollers according to an embodiment;

FIG. 6 is a graph showing a moving speed of the electrode according to an embodiment;

FIG. 7 is a view illustrating a setting interface according to an embodiment;

FIG. 8 is a view illustrating a prediction interface according to an embodiment;

FIG. 9, FIG. 10, and FIG. 11 are graphs showing three prediction results in which an opening gap is the same while an opening time is different;

FIG. 12, FIG. 13, and FIG. 14 are graphs showing three prediction results in which the opening time is the same while the opening gap is different;

FIG. 15 is a flowchart illustrating a process of generating a prediction model according to an embodiment;

FIG. 16 is a graph describing a support vector machine for generating the prediction model according to an embodiment;

FIG. 17 is a portion of training data for generating the prediction model according to an embodiment;

FIG. 18 is a graph showing the performance of the prediction model according to an embodiment;

FIG. 19, FIG. 20, FIG. 21, and FIG. 22 are graphs comparing true values and predicted values of the prediction model according to an embodiment;

FIG. 23 is a flowchart illustrating each process of a control method of the electrode rolling apparatus according to an embodiment; and

FIG. 24 is a flowchart illustrating processes for determining the opening gap and a speed at the opening time according to an embodiment.

### DETAILED DESCRIPTION

Hereinafter, the present disclosure will be described in detail with reference to the accompanying drawings. However, those skilled in the art will appreciate that such embodiments are provided to further understand the spirit of the present disclosure and do not limit subject matters to be protected as disclosed in the detailed description and appended claims.

Hereinafter, an embodiment of the present disclosure will be described in detail with reference to the accompanying drawings.

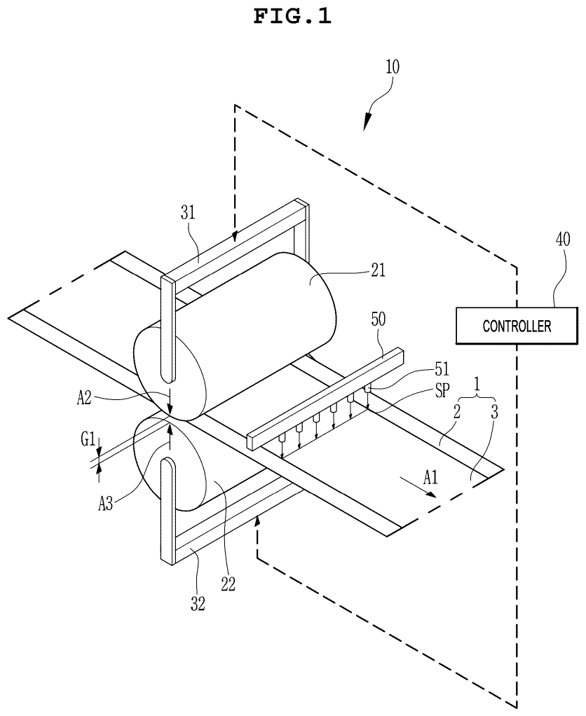

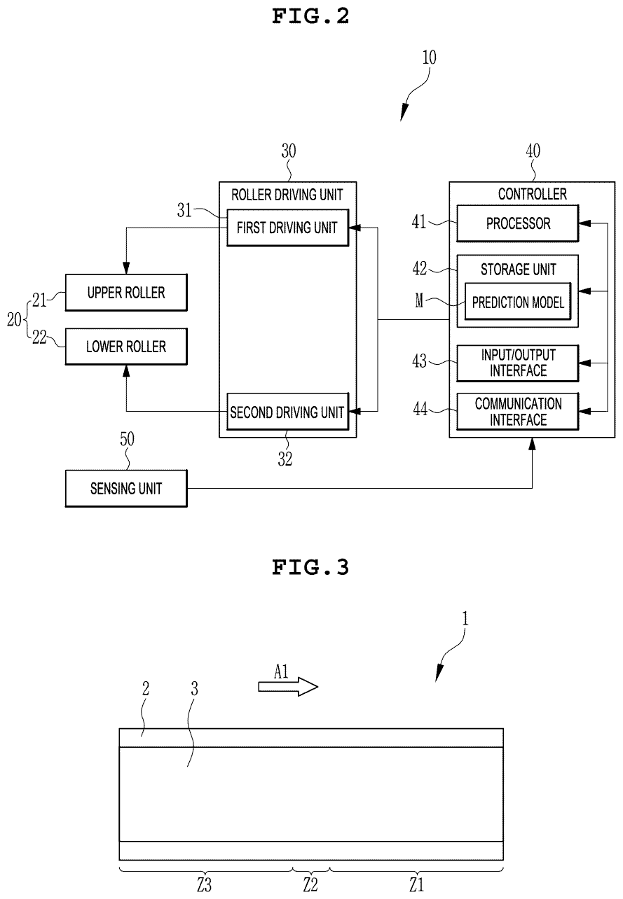

FIG. 1 is a view illustrating an electrode rolling apparatus 10 according to an embodiment. FIG. 2 is a block diagram illustrating the electrode rolling apparatus 10 according to an embodiment.

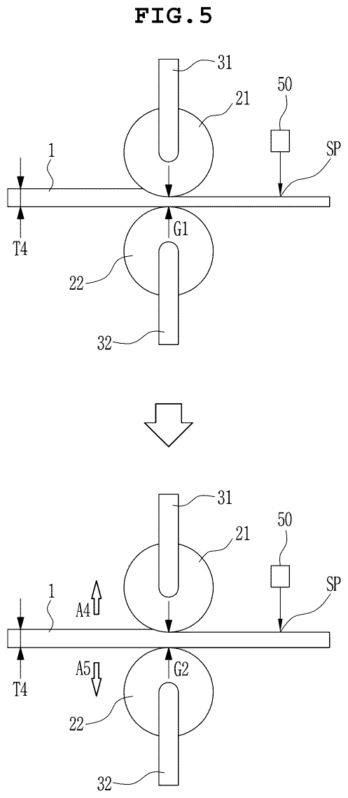

An electrode rolling apparatus 10 may comprise an upper roller 21, a lower roller 22 spaced apart from the upper roller 21 by a predetermined distance, a roller driving unit 30 configured to rotate the upper roller 21 and the lower roller 22 and to adjust a gap between the upper roller 21 and the lower roller 22, and a controller 40 configured to control the roller driving unit 30 so that the gap between the upper roller 21 and the lower roller 22 expands up to an opening gap G2 (see FIG. 5) when a rolling process in which an electrode 1 moving in one direction is rolled by passing between the upper roller 21 and the lower roller 22 is temporarily stopped.

The electrode 1 may comprise a current collector 2 and a mixture layer 3 coated on the current collector 2. An active material, a binder, and so on are mixed in the mixture layer 3. When the electrode 1 is rolled, the thickness of the mixture layer 3 may be decreased. Accordingly, the overall thickness of the electrode 1 may be decreased.

The upper roller 21 and the lower roller 22 may roll the electrode 1. The upper roller 21 and the lower roller 22 may be rotated in a moving direction A1 of the electrode 1. The upper roller 21 and the lower roller 22 may perform rolling while the upper roller 21 and the lower roller are spaced apart from each other by a predetermined production gap G1. The production gap G1 may be set smaller than the thickness of the electrode 1 before rolling, so that the upper roller 21 and the lower roller 22 are capable of rolling the electrode 1.

The roller driving unit 30 may drive the upper roller 21 and the lower roller 22. The roller driving unit 30 may comprise a first driving unit 31 configured to drive the upper roller 21, and may comprise a second driving unit 32 configured to drive the lower roller 22. The first driving unit 31 may rotate the upper roller 21, and may press the upper roller 21 such that the upper roller 21 is moved in a direction A2 so that the upper roller 21 is positioned close to the lower roller 22. The second driving unit 32 may rotate the lower roller 22, and may press the lower roller 22 such that the lower roller 22 is moved in a direction A3 so that the lower roller 22 is positioned close to the upper roller 21. The roller driving unit 30 may move the upper roller 21 and the lower roller 22 such that the gap between the upper roller 21 and the lower roller 22 is decreased or increased. An increase in the gap between the upper roller 21 and the lower roller 22 may be referred to as rollers 20 (the upper roller 21 and the lower roller 22) being opened. A decrease in the gap between the upper roller 21 and the lower roller 22 may be referred to as the rollers 20 being closed.

The controller 40 may adjust the gap between the upper roller 21 and the lower roller 22 by controlling the roller driving unit 30. The controller 40 may be a computing device capable of processing information. The controller 40 may be a PLC, a process management system, a PC, a tablet PC, or another computing device.

The controller 40 may comprise a processor 41, a storage unit 42 connected to the processor 41 and configured such that data transmission and reception is capable of being realized, and an input/output interface 43 connected to the processor 41 and configured such that information and data are capable of being displayed to a user and an instruction is capable of being input thereto. The controller 40 may further comprise a communication interface 44 connected to a wired or wireless network and configured to transmit and receive data or an instruction.

The processor 41 may perform a control method of the electrode rolling apparatus by executing program code stored in the storage unit 42. The storage unit 42 may store a program code, a prediction model M, and other data. The input/output interface 43 may comprise a display device configured to display a setting interface IF1, a prediction interface IF2, and other information, and may comprise an input device comprising a mouse, a keyboard, a touch panel, a button, and so on. The communication interface 44 may be connected to the wired or wireless network, and may transmit and receive data or an instruction.

When the rolling process of rolling the electrode 1 is temporarily stopped, the controller 40 may control the roller driving unit 30 so that the gap between the upper roller 21 and the lower roller 22 is increased. The controller 40 may control the upper roller 21 and the lower roller 22 such that the gap between the upper roller 21 and the lower roller 22 is increased up to the opening gap G2.

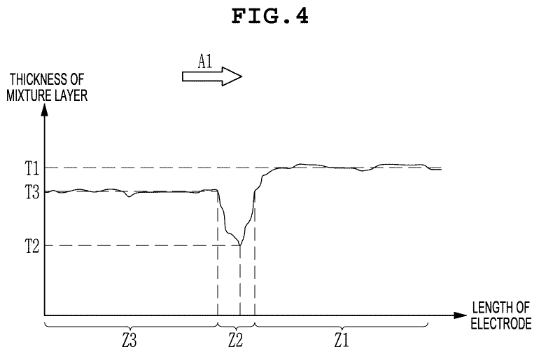

Referring to FIG. 3 and FIG. 4, a phenomenon occurring when the rolling process is temporarily stopped will be described. FIG. 3 is a view illustrating a portion of the rolled electrode 1 according to an embodiment. FIG. 4 is a graph illustrating the thickness of the rolled electrode 1 according to an embodiment. FIG. 1 will be referred to together with the following description.

When the rolling process of rolling the electrode 1 is temporarily stopped, a partial section of the electrode 1 maintained in a rolled state between the upper roller 21 and the lower roller 22 may be over-rolled. Over-rolling means that the thickness of the rolled electrode 1 is smaller than the lower limit of a production thickness range. The production thickness range is a criterion for determining whether the rolled electrode 1 is normal. The rolled electrode 1 having the thickness that is outside the production thickness range may be treated as defective. In FIG. 3 and FIG. 4, a stop-rolling section Z2 is a section in which the rolling process is temporarily stopped and the electrode 1 is over-rolled since the electrode 1 is maintained in the rolled state between the upper roller 21 and the lower roller 22. A pre-stop rolling section Z1 is a section in which the electrode 1 is rolled by passing between the upper roller 21 and the lower roller 22 before the rolling press is temporarily stopped. A post-stop rolling section Z3 is a section in which the electrode 1 is rolled as the rolling process is resumed after the rolling process is temporarily stopped.

The electrode rolling apparatus 10 may further comprise a sensing unit 50 configured to sense the thickness of the rolled electrode 1. The sensing unit 50 may sense the thickness of the rolled electrode 1 rolled by the upper roller 21 and the lower roller 22, and may transmit the sensed thickness of the rolled electrode 1 to the controller 40. The sensing unit 50 may comprise at least one sensor 51. The sensor 51 may comprise a distance measurement sensor 51. The sensor 51 may comprise various types of sensors such as laser, infrared, or ultrasonic sensors. The sensing unit 50 may comprise a plurality of sensors 51 spaced apart from each other by a predetermined distance in a width direction of the electrode 1. For example, the sensing unit 50 may comprise six sensors 51 arranged in the width direction of the electrode 1, so that the thickness of the electrode 1 may be sensed at six sensing points SP.

A thickness T1 of the electrode 1 in the pre-stop rolling section Z1 is larger than a thickness T3 of the electrode 1 in the post-stop rolling section Z3. After the electrode 1 is rolled, the thickness of the electrode 1 may be partially increased due to a springback phenomenon as time elapses. The springback phenomenon may occur due to a restoring force inside the mixture layer 3. Since the thickness T1 of the electrode 1 in the pre-stop rolling section Z1 is sensed when the rolling process is temporarily stopped, the electrode 1 being in a state in which the thickness is increased due to the springback phenomenon. Therefore, the thickness T1 may be sensed to be larger than the thickness T3 of the electrode 1 in the post-stop rolling section Z3. The thickness T3 of the electrode 1 in the post-stop rolling section Z3 is sensed immediately after the electrode 1 is rolled by the upper roller 21 and the lower roller 22, so that the thickness T3 is sensed before the influence of the springback phenomenon appears. Therefore, the thickness T3 may be smaller than the thickness T1 of the electrode in the pre-stop rolling section Z1. The thickness T2 of the electrode 1 in the stop-rolling section Z2 is the thickness of the electrode 1 at a portion in the rolled state by the upper roller 21 and the lower roller 22 while the rolling process is stopped. Therefore, the electrode 1 in the stop-rolling section Z2 is over-rolled, so that the thickness T2 of the electrode 1 in the stop-rolling section Z2 may be sensed as the lowest.

The electrode 1 corresponding to the over-rolled electrode 1 in the stop-rolling section Z2 may be treated as defective. A small difference (for example, 3 μm to 4 μm) exists between the thickness T2 of the electrode 1 in the stop-rolling section Z2 and the thicknesses T1 and T3 of the electrode 1 in other sections. In addition, the stop-rolling section Z2 is a very short portion along the entire length of the electrode 1. Therefore, the over-rolling of the electrode 1 in the stop-rolling section Z2 is difficult to detect with the sensing unit 50 and the color difference between the stop-rolling section Z2 and other sections Z1 and Z3 is very small, so that it is also difficult to detect the over-rolling of the electrode 1 by using a vision-based detection method employing a camera.

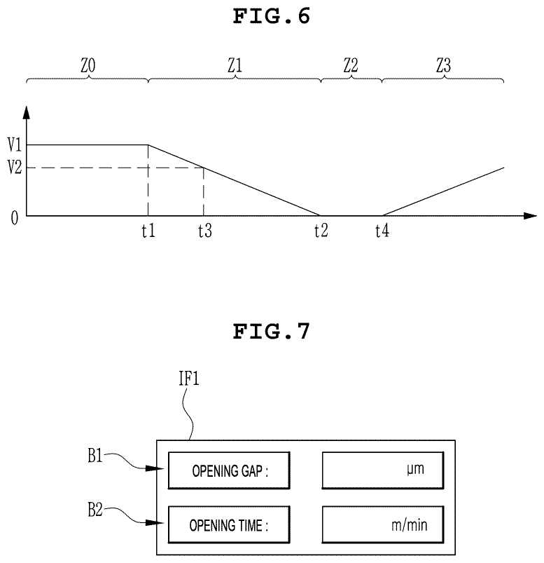

FIG. 5 is a view illustrating an operation of the rollers 20 according to an embodiment. FIG. 6 is a view illustrating a moving speed of the electrode 1 according to an embodiment.

According to an embodiment, when the rolling process is temporarily stopped, the controller 40 may increase the gap between the upper roller 21 and the lower roller 22. When the gap between the upper roller 21 and the lower roller 22 is increased, a portion of the electrode 1 positioned between the upper roller 21 and the lower roller 22 may not be over-rolled while the rolling process is temporarily stopped. Therefore, the phenomenon in which the electrode 1 is over-rolled in the stop-rolling section Z2 described with reference to FIG. 3 and FIG. 4 is capable of being prevented. Since the electrode 1 in the stop-rolling section Z2 is not over-rolled, the electrode 1 corresponding to that portion may not be treated as defective, and the production yield may be increased.

While the rolling process is performed, the controller 40 may maintain the gap between the upper roller 21 and the lower roller 22 spaced apart by the production gap G1. When the rolling process is temporarily stopped, the controller 40 may maintain the gap between the upper roller 21 and the lower roller 22 spaced apart by the opening gap G2. The opening gap G2 is a gap determined to prevent over-rolling. The opening gap G2 may be larger than the production gap G1. The opening gap G2 may be smaller than the thickness T4 of the electrode 1 before rolling. An input value of the opening gap G2 may be input by a user.

When the rolling process is temporarily stopped, the controller 40 may control the roller driving unit 30 such that the gap between the upper roller 21 and the lower roller 22 is increased from an opening time t3 that is a time point at which the moving speed of the electrode 1 is reduced to a predetermined speed.

During a normal rolling section Z0 in which the rolling process is normally performed, the electrode 1 may be moved at a production speed V1. That is, in the normal rolling section, the electrode 1 may be moved at the production speed V1. When the rolling process is temporarily stopped for various reasons related to the rolling process, the moving speed of the electrode 1 may be gradually decreased. At a time t2 when the moving speed of the electrode 1 becomes zero, the rolling process of the electrode 1 is stopped. A section starting from a time t1 when a decision to stop the rolling process is made to the time t2 when the moving speed of the electrode 1 becomes zero may be defined as the pre-stop rolling section Z1.

The controller 40 may increase the gap between the upper roller 21 and the lower roller 22 from the opening time t3 within the pre-stop rolling section Z1. The opening time t3 may be determined as a time when the moving speed of the electrode 1 is reduced from the production speed V1 to a predetermined speed V2. For example, when the moving speed of the electrode 1 is 100 m/min at the pre-stop rolling section Z1, the opening time t3 may be determined as a time when the speed is reduced to 5 m/min. When the opening time t3 is set to a time when the speed of the electrode 1 is reduced to 10 m/min, the opening time t3 of the upper roller 21 and the lower roller 22 is considered early. Furthermore, when the opening time t3 is set to a time when the speed of the electrode 1 is reduced to 3 m/min, the opening time t3 is considered late. An increase in the opening time t3 indicates an earlier opening, and a decrease in the opening time t3 indicates a later opening. An input value of the speed V2 at the opening time t3 may be input by the user.

When the rolling process is temporarily stopped, the controller 40 may control the roller driving unit 30 so that the gap between the upper roller 21 and the lower roller 22 is increased at a roller moving speed at which the upper roller 21 and the lower roller 22 are moved away from each other.

The roller moving speed indicates how quickly the gap between the upper roller 21 and the lower roller 22 is increased or decreased. When the roller moving speed is high, the gap between the upper roller 21 and the lower roller 22 may be increased rapidly. When the roller moving speed is low, the gap between the upper roller 21 and the lower roller 22 may be increased slowly. For example, the roller moving speed may be determined according to a specification of the roller driving unit 30.

The controller 40 may control the roller driving unit 30 such that only one of the upper roller 21 or the lower roller 22 is moved so that the gap between the upper roller 21 and the lower roller 22 is increased, or may control the roller driving unit 30 such that both the upper roller 21 and the lower roller 22 are moved so that the gap between the upper roller 21 and the lower roller 22 is increased. The roller driving unit 30 may adjust the gap between the upper roller 21 and the lower roller 22 by using the first driving unit 31 that operates the upper roller 21 and the second driving unit 32 that operates the lower roller 22.

The controller 40 may increase the gap between the upper roller 21 and the lower roller 22 by moving only the lower roller 22 in a downward direction A5. The controller 40 may increase the gap between the upper roller 21 and the lower roller 22 by moving only the upper roller 21 in an upward direction A4. The controller 40 may increase the gap between the upper roller 21 and the lower roller 22 by moving the upper roller 21 in the upward direction A4 and moving the lower roller 22 in the downward direction A5.

FIG. 7 is a view illustrating the setting interface IF1 according to an embodiment.

The controller 40 may provide the setting interface IF1 configured to receive input values of the opening time t3 at which the upper roller 21 and the lower roller 22 start to be move away from each other, and the opening gap G2 at which the upper roller 21 and the lower roller 22 are moved away from each other. The setting interface IF1 may comprise an item B1 for receiving an input value of the opening gap G2, and may comprise an item B2 for receiving an input value of the opening time t3. The setting interface IF1 may be provided to the user through the input/output interface 43 of the controller 40. The setting interface IF1 may be displayed on the display of the input/output interface 43, and the user may input the input value of the opening gap G2 and the input value of the opening time t3 by using the input device such as a touch panel, a keyboard, or a mouse of the input/output interface 43.

The setting interface IF1 may receive the input value of the opening gap G2 in units of μm. The setting interface IF1 may receive the input value of the opening time t3 in units of m/min. The units for receiving the input value of the opening gap G2 and the input value of the opening time t3 through the setting interface IF1 may be changed.

When the user inputs the input value of the opening gap G2 and the input value of the opening time t3 through the setting interface IF1, the controller 40 may move the upper roller 21 and the lower roller 22 according to the input values.

Table 1 below shows the change in the thickness of the electrode 1 according to changes in the opening gap G2, the opening time t3, the roller moving speed, and the stopping period.

TABLE 1

| | Thickness T2 | Thickness T1 | Thickness T3 |
|---|---|---|---|
| | at the | at the pre-stop | at the post-stop |
| | stop-rolling | rolling | rolling |
| | section Z2 | section Z1 | section Z3 |
| Increase in the | Increase | Irrelevant | Irrelevant |
| opening gap G2 | | | |
| Increase in | Increase | Increase | Irrelevant |
| speed at the | | | |
| opening | | | |
| time t3 | | | |
| Increase in the | Increase | Increase | Decrease |
| roller moving | | | |
| speed | | | |
| Increase in | Decrease | Increase | Irrelevant |
| stopping period | | | |

When the opening gap G2 is increased, the gap between the upper roller 21 and the lower roller 22 is increased, so that the pressure applied to the electrode 1 positioned between the upper roller 21 and the lower roller 22 may be reduced. Therefore, the thickness of the electrode 1 in the stop-rolling section Z2 may be increased. Conversely, when the opening gap G2 is decreased, the thickness of the electrode 1 in the stop-rolling section Z2 may be decreased. The thickness of the electrode 1 in the pre-stop rolling section Z1 is irrelevant to the increase or the decrease in the opening gap G2. This is because the electrode 1 in the pre-stop rolling section Z1 has already passed between the upper roller 21 and the lower roller 22. The thickness of the electrode 1 in the post-stop rolling section Z3 is irrelevant to the increase or the decrease in the opening gap G2. This is because the post-stop rolling section Z3 is a place where the electrode 1 is rolled while the gap between the upper roller 21 and the lower roller 22 is maintained at the production gap G1.

When the opening time t3 is increased, the upper roller 21 and the lower roller 22 start to move away from each other earlier time after the determination that the rolling process is temporarily stopped, so that the pressure applied to the electrode 1 in the pre-stop rolling section Z1 and in the stop-rolling section Z2 by the upper roller 21 and the lower roller 22 may be reduced. Therefore, the thickness of the electrode 1 in the pre-stop rolling section Z1 and the stop-rolling section Z2 may be increased. Conversely, when the opening time t3 is decreased, the upper roller 21 and the lower roller 22 start to move away later after it is determined that the rolling process is temporarily stopped, so that the pressure applied to the electrode 1 in the pre-stop rolling section Z1 and in the stop-rolling section Z2 by the upper roller 21 and the lower roller 22 may be increased. Therefore, the thickness of the electrode 1 in the pre-stop rolling section Z1 and the stop-rolling section Z2 may be decreased.

The thickness of the electrode 1 in the post-stop rolling section Z3 is irrelevant to the increase or the decrease in the opening time t3. This is because the post-stop rolling section Z3 is a place where the electrode 1 is rolled while the gap between the upper roller 21 and the lower roller 22 is maintained at the production gap G1.

When the roller moving speed is increased, the gap between the upper roller 21 and the lower roller 22 is rapidly increased from the opening time t3, so that the pressure applied to the electrode 1 in the pre-stop rolling section Z1 and in the stop-rolling section Z2 by the upper roller 21 and the lower roller 22 may be decreased. Therefore, the thickness of the electrode 1 in the pre-stop rolling section Z1 and the stop-rolling section Z2 may be increased. Conversely, when the roller moving speed is decreased, the gap between the upper roller 21 and the lower roller 22 is slowly increased from the opening time t3, so that the pressure applied to the electrode 1 in the pre-stop rolling section Z1 and in the stop-rolling section Z2 may be increased. Therefore, the thickness of the electrode 1 in the pre-stop rolling section Z1 and the stop-rolling section Z2 may be decreased.

When the roller moving speed is increased, the rollers 20 approach the production gap G1 more quickly at a time t4 when the rolling process is resumed after the temporary stop, so that the pressure applied to the electrode 1 by the upper roller 21 and the lower roller 22 may be increased. Therefore, the thickness of the electrode 1 in the post-stop rolling section Z3 may be decreased. Conversely, when the roller moving speed is decreased, the rollers 20 approach the production gap G1 more slowly at the time t4, so that the pressure applied to the electrode 1 by the upper roller 21 and the lower roller 22 may be decreased. Therefore, the thickness of the electrode 1 in the post-stop rolling section Z3 may be increased.

When the period during which the rolling process is temporarily stopped (from t2 to t4) is increased, the thickness of the electrode 1 in the stop-rolling section Z2 may be decreased. This is because the time during which the electrode 1 is pressed by the upper roller 21 and the lower roller 22 increases.

When the stopping period (from t2 to t4) in which the rolling process is temporally stopped is increased, the thickness of the electrode 1 in the pre-stop rolling section Z1 may be increased. This is because a sufficient time is given for the thickness of the electrode 1 to be recovered due to the springback phenomenon.

The thickness of the electrode 1 in the post-stop rolling section Z3 is irrelevant to the increase or the decrease in the stopping period (from t2 to t4) in which the rolling process is temporarily stopped. This is because the post-stop rolling section Z3 is a place where the electrode 1 is rolled while the gap between the upper roller 21 and the lower roller 22 is maintained at the production gap G1.

The opening gap G2, the opening time t3, the roller moving speed, and the stopping period described with reference to Table 1 may each affect the thickness of the electrode 1, and each change in the opening gap G2, the opening time t3, the roller moving speed, and the stopping period may collectively affect the thickness of the electrode 1. The relative difference between the rotational speed of the rollers 20 and the moving speed of the electrode 1 may also affect the thickness of the electrode 1. Due to friction between the rollers 20 and the electrode 1, the electrode 1 may be pressed while the electrode 1 is dragged or stopped by the rollers 20. When the friction force between the rollers 20 and the electrode 1 is large, pressure concentration and surface deformation may occur on the surface of the electrode 1, so that it may be difficult to determine the value of the opening time t3 and the value of the opening gap G2 accurately. The thickness of the electrode 1, the content ratio of the active material and the binder in the mixture layer 3, and other factors may also affect the rolling of the electrode 1. Therefore, a plurality of tests may be required to be performed for determining an appropriate opening gap G2 and an appropriate opening time t3.

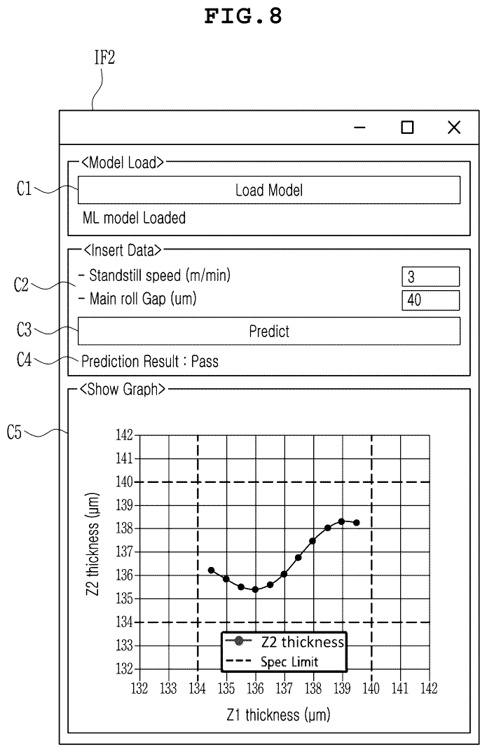

FIG. 8 is a view illustrating the prediction interface IF2 according to an embodiment.

The controller 40 may provide the prediction interface IF2 configured to predict the thickness of the electrode 1 in the stop-rolling section Z2 by using a prediction model M that is generated by training, through a regression modeling method, training data collected while the rolling process is performed on the electrode 1 and then the rolling process is temporarily stopped. In the training data, the thickness of the electrode 1 in the pre-stop rolling section Z1, the opening gap G2, and the opening time t3 are used as independent variables and the thickness of the electrode 1 in the stop-rolling section Z2 is used as a dependent variable.

The user may input the input value of the opening gap G2 and the input value of the opening time t3 to the prediction interface IF2, and may check the thickness of the electrode 1 in the stop-rolling section Z2 predicted according to the input values of the opening gap G2 and the opening time t3. The user may check whether the thickness of the electrode 1 in the stop-rolling section Z2 is comprised in a production thickness range. By using the prediction interface IF2, the appropriate opening gap G2 and the appropriate opening time t3 may be determined without actually performing a test process in which the electrode 1 is actually rolled, stopped, resumed, and then the thickness of the electrode 1 is sensed.

The prediction interface IF2 may display an item C1 (Load Model) for loading a model. When a model load button is selected, a list of trained prediction models M stored in the storage unit 42 is displayed, and the user may select any one of the trained prediction models M displayed in the list. The controller 40 may predict the thickness of the electrode 1 in the stop-rolling section Z2 by using the prediction model M selected by the user.

The prediction interface IF2 may comprise an item C2 (Main roll Gap: an opening gap, and Standstill speed: an opening time), and may comprise a prediction button C3. When the user inputs the input value of the opening gap G2 and the opening time t3 that the user intend to test to the prediction interface IF2 and then selects the prediction button C3, the controller 40 may input the input value of the opening gap G2 and the opening time t3 that the user inputs and the thickness of the electrode 1 in the pre-stop rolling section Z1, and may display the thickness of the electrode 1 in the stop-rolling section Z2 predicted by the prediction model M on the prediction interface IF2. The value of the thickness of the electrode 1 in the pre-stop rolling section Z1 is a preset value, and is stored in the controller 40.

The value of the thickness of the electrode 1 in the pre-stop rolling section Z1 is a target thickness of the electrode 1, and may be stored in the controller 40. The controller 40 may repeatedly operate the prediction model M that is trained to predict the thickness of the electrode 1 in the stop-rolling section Z2 for each value within an allowable range on the basis of the target value of the thickness of the electrode 1 in the pre-stop rolling section Z1.

For example, when the target value of the thickness of the electrode 1 in the pre-stop rolling section Z1 is 137 μm, the allowable range of the thickness of the electrode 1 in the pre-stop rolling section Z1 may be from 134 μm to 140 μm. The allowable range of thickness of the electrode 1 in the pre-stop rolling section Z1 may refer to a thickness variation of the electrode 1 that can occur due to wear of the upper roller 21 and the lower roller 22, a condition of the mixture layer 3, and other errors that arise from various causes when rolling is performed on the basis of the target value. The allowable range of thickness of the electrode 1 in the pre-stop rolling section Z1 may be the same as a criterion used to determine a normal product. That is, when the thickness of the electrode 1 in the pre-stop rolling section Z1 is within 134 μm to 140 μm, the product may be determined to be a normal product.

When the rolling process is performed as described above, the thickness of the electrode 1 in the pre-stop rolling section Z1 may have a value different from the target value due to various factors. Therefore, even when the electrode 1 is rolled to a thickness which is not the target value but which is comprised in the allowable range of the thickness of the electrode 1 in the pre-stop rolling section Z1, the thickness of the electrode 1 in the stop-rolling section Z2 is required to be comprised within the allowable range. For example, even when the thickness of the electrode 1 in the pre-stop rolling section Z1 is 134 μm or 140 μm, the thickness of the electrode 1 in the stop-rolling section Z2 is required to be comprised within the allowable range of 134 μm to 140 μm.

The controller 40 may input each candidate value comprised within the allowable range of the thickness of the electrode 1 in the pre-stop rolling section Z1 and the opening gap G2 and the opening time t3 input by the user to the trained prediction model M, so that the thickness of the electrode 1 in the stop-rolling section Z2 may be predicted for each candidate value. That is, when the user inputs the input value of the opening gap G2 and the input value of the opening time t3 and then selects the prediction button C3, the controller 40 may repeatedly perform prediction by using the trained prediction model M as many times as the number of candidate values (for example, 11 in FIG. 8) comprised within the allowable range of the thickness of the electrode 1 in the pre-stop rolling section Z1. Accordingly, the controller 40 may predict a plurality of thickness values of the electrode 1 in the stop-rolling section Z2. Each candidate value may be preset at a predetermined interval within the allowable range around the target value that is stored in advance. For example, in FIG. 8, the candidate values may be 134.5 μm, 135.0 μm, 135.5 μm, 136.0 μm, 136.5 μm, 137.0 μm, 137.5 μm, 138.0μ, 138.5 μm, 139.0 μm, and 139.5 μm.

In FIG. 8, the thickness of the electrode 1 in the stop-rolling section Z2 may be displayed on a graph C5.

In the prediction interface IF2, when the opening gap G2 and the opening time t3 are input and the prediction button C3 is selected, the graph C5 indicating whether the predicted thickness of the electrode 1 in the stop-rolling section Z2 for each preset candidate value within the allowable range of the thickness of the electrode 1 in the pre-stop rolling section Z1 is outside a normal range may be displayed.

The prediction interface IF2 may display the thickness of the electrode 1 in the stop-rolling section Z2 predicted by the prediction model M in the form of the graph C5. In the graph, the horizontal axis represents the thickness of the electrode 1 in the pre-stop rolling section Z1 (Z1 thickness), and the vertical axis represents the thickness of the electrode 1 in the stop-rolling section Z2 (Z2 thickness). The graph C5 may display the predicted thickness values of the electrode 1 in the stop-rolling section Z2 for each of the 11 candidate values. For example, it can be seen that the predicted thickness of the electrode 1 in the stop-rolling section Z2 is 136.3 μm when the candidate value of the thickness of the electrode 1 in the pre-stop rolling section Z1 is 134.5 μm, and it can be seen that the predicted thickness of the electrode 1 in the stop-rolling section Z2 is 135.5 μm when the candidate value of the thickness of the electrode 1 in the pre-stop rolling section Z1 is 136.0 μm. Since the predicted thickness of the electrode 1 in the stop-rolling section Z2 is displayed for each candidate value, the user may determine whether the predicted thickness of the electrode 1 in the stop-rolling section Z2 corresponding to each thickness of the electrode 1 in the pre-stop rolling section Z1 within the allowable range is comprised within the production thickness range.

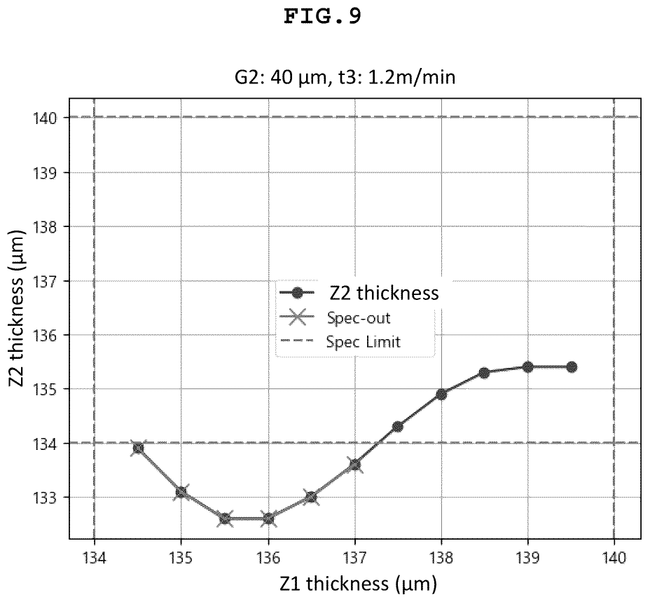

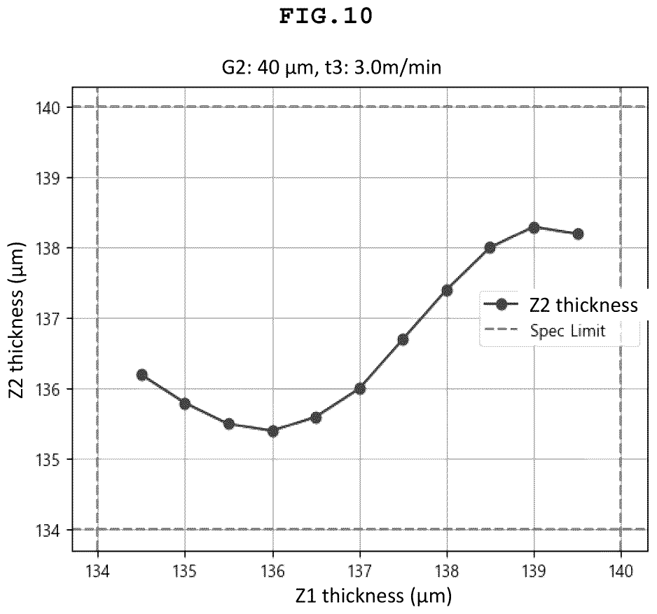

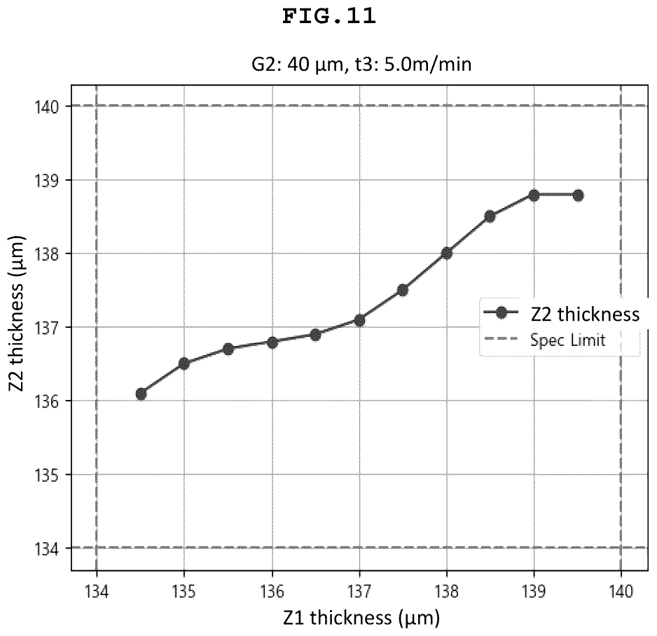

FIG. 9, FIG. 10, and FIG. 11 are graphs showing three prediction results in which the opening gap G2 is the same while the opening time t3 is different. In FIG. 9, FIG. 10, and FIG. 11, the vertical dotted lines indicate lower and upper limits (Spec Limit) of the production thickness range in the pre-stop rolling section Z1, and the horizontal dotted lines indicate lower and upper limits (Spec limit) of the production thickness range in the stop-rolling section Z2. Here, the production thickness range in the pre-stop rolling section Z1 may be 134 μm to 140 μm, and the production thickness range in the stop-rolling section Z2 may be 134 μm to 140 μm.

By using the prediction interface IF2, the user is capable of checking the difference in the thickness of the electrode 1 in the stop-rolling section Z2 resulting from differences in the opening time t3 when the opening gap G2 is the same. When the opening gap G2 is set to 40 μm, the opening time t3 is set to 1.2 m/min, and then the prediction button is selected on the prediction interface IF2, the graph shown in FIG. 9 may be displayed. When the opening gap G2 is set to 40 μm, the opening time t3 is set to 3.0 m/min, and then the prediction button is selected on the prediction interface IF2, the graph shown in FIG. 10 may be displayed. When the opening gap G2 is set to 40 μm, the opening time t3 is set to 5.0 m/min, and then the prediction button is selected on the prediction interface IF2, the graph shown in FIG. 11 may be displayed.

In FIG. 9, it can be seen that the allowable range of the thickness of the electrode 1 in the pre-stop rolling section Z1 (Z1 thickness) is 134 μm to 140 μm, 11 candidate values exist within the range, and the predicted thickness of the electrode 1 in the stop-rolling section Z2 (Z2 thickness) is displayed for each candidate value. As can be seen from the graph, when the thickness of the electrode 1 in the pre-stop rolling section Z1 ranges from 134.5 μm to 137 μm, the thickness of the electrode 1 in the stop-rolling section Z2 is predicted to be less than 134 μm, and it can be seen that the thickness of the electrode 1 in the stop-rolling section Z2 (Z2 thickness) is outside the production thickness range. Therefore, during the rolling process, when the thickness of the electrode 1 in the pre-stop rolling section Z1 is between 134.5 μm and 137 μm, the thickness of the electrode 1 in the stop-rolling section Z2 may be interpreted as being outside the production thickness range. Accordingly, in the prediction interface IF2, a result C4 may be displayed as “Fail”.

In FIG. 10 and FIG. 11, it can be seen that the thickness of the electrode 1 in the stop-rolling section Z2 (Z2 thickness) is positioned between 134 μm and 140 μm for each candidate value within the allowable thickness of the electrode 1 in the pre-stop rolling section Z1 (Z1 thickness). Therefore, during the rolling process, it can be interpreted that the thickness of the electrode 1 in the stop-rolling section Z2 remains within the production thickness range regardless of which candidate value of the thickness of the electrode 1 in the pre-stop rolling section Z1 within the allowable range is used. Accordingly, in the prediction interface IF2, the result C4 may be displayed as “Pass”.

It can also be seen that the thickness of the electrode 1 in the stop-rolling section Z2 in FIG. 11 is closer to the center of the production thickness range (137 μm) than the thickness of the electrode 1 in the stop-rolling section Z2 in FIG. 10. By comparing the graphs in FIG. 10 and FIG. 11, the user may select the condition of the opening time t3 in FIG. 11, in which the thickness of the electrode 1 in the stop-rolling section Z2 is thicker than the thickness of the electrode 1 in the stop-rolling section Z2 in FIG. 10, and in which the thicknesses of the electrode in the pre-stop rolling section Z1 and in the stop-rolling section Z2 show an overall proportional relationship.

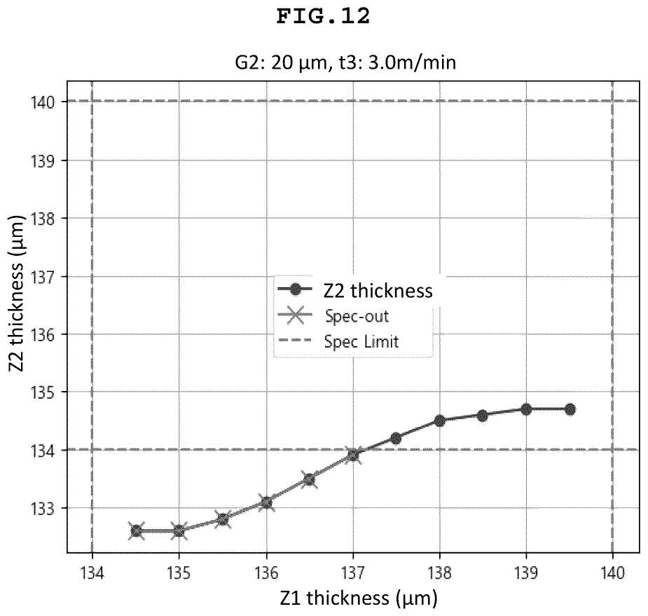

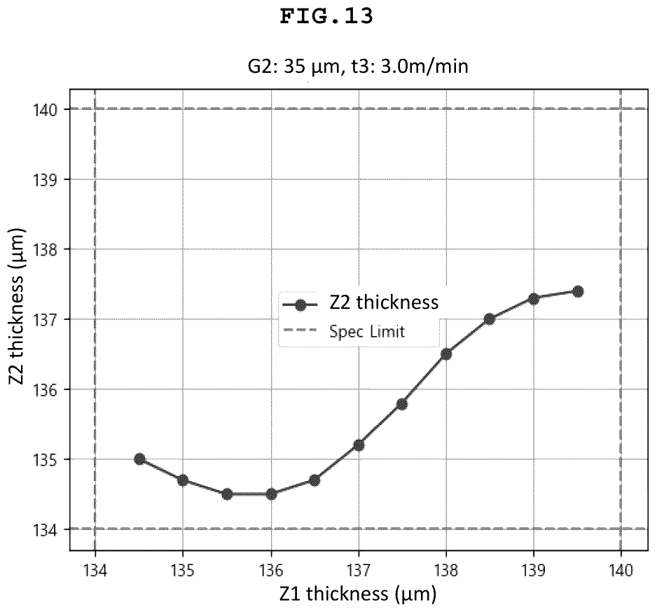

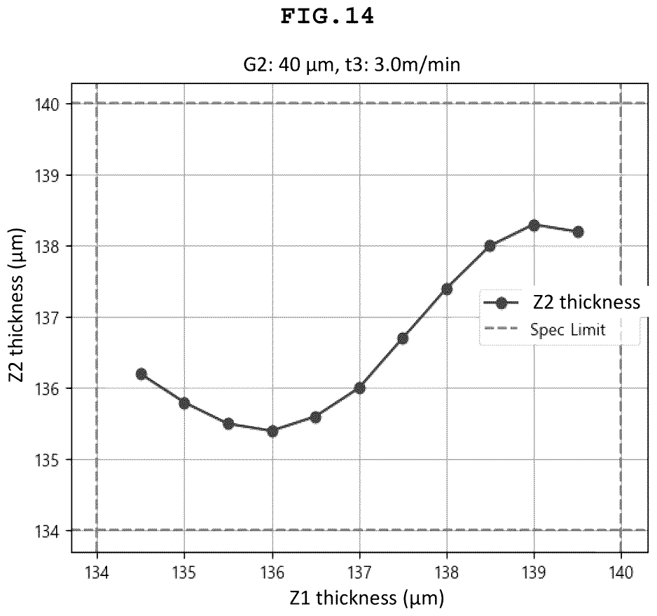

FIG. 12, FIG. 13, and FIG. 14 are graphs showing three predicted results in which the opening time t3 is the same while the opening gap G2 is different. In FIG. 12, FIG. 13, and FIG. 14, the vertical dotted lines indicate limits (spec limit; lower and upper limits) of the production thickness range in the pre-stop rolling section Z1, and the horizontal dotted lines indicate limits (spec limit; lower and upper limits) of the production thickness range in the stop-rolling section Z2. Here, the production thickness range in the pre-stop rolling section Z1 may be 134 μm to 140 μm, and the production thickness range in the stop-rolling section Z2 may be 134 μm to 140 μm.

By using the prediction interface IF2, the user may check the difference in the thickness of the electrode 1 in the stop-rolling section Z2 resulting from differences in the opening gap G2 when the opening time t3 is the same. When the opening gap G2 is set to 20 μm, the opening time t3 is set to 3.0 m/min, and then the prediction button is selected on the prediction interface IF2, the graph shown in FIG. 12 may be displayed. When the opening gap G2 is set to 35 μm, the opening time t3 is set to 3.0 m/min, and then the prediction button is selected on the prediction interface IF2, the graph shown in FIG. 13 may be displayed. When the opening gap G2 is set to 40 μm, the opening time t3 is set to 3.0 m/min, and then the prediction button is selected on the prediction interface IF2, the graph shown in FIG. 14 may be displayed.

In FIG. 12, it can be seen that the allowable range of the thickness of the electrode 1 in the pre-stop rolling section Z1 (Z1 thickness) is 134 μm to 140 μm, 11 candidate values exist within the range, and the predicted thickness of the electrode 1 in the stop-rolling section Z2 is displayed for each candidate value. As can be seen from the graph, when the thickness of the electrode 1 in the pre-stop rolling section Z1 ranges from 134.5 μm to 137 μm, the thickness of the electrode 1 in the stop-rolling section Z2 is predicted to be less than 134 μm, and it can be seen that the thickness of the electrode 1 in the stop-rolling section Z2 (Z2 thickness) is outside the production thickness range. Therefore, during the rolling process, when the thickness of the electrode 1 in the pre-stop rolling section Z1 is between 134.5 μm and 137 μm, the thickness of the electrode 1 in the stop-rolling section Z2 may be interpreted as being outside the production thickness range. Accordingly, in the prediction interface IF2, a result C4 may be displayed as “Fail”.

In FIG. 13 and FIG. 14, it can be seen that the thickness of the electrode 1 in the stop-rolling section Z2 (Z2 thickness) is positioned between 134 μm and 140 μm for each candidate value within the allowable thickness of the electrode 1 in the pre-stop rolling section Z1 (Z1 thickness). Therefore, during the rolling process, it can be interpreted that the thickness of the electrode 1 in the stop-rolling section Z2 remains within the production thickness range regardless of which candidate value of the thickness of the electrode 1 in the pre-stop rolling section Z1 within the allowable range is used. Accordingly, in the prediction interface IF2, the result C4 may be displayed as “Pass”.

It can also be seen that the thickness of the electrode 1 in the stop-rolling section Z2 in FIG. 14 is generally larger than that in FIG. 13. By comparing these graphs in FIG. 13 and FIG. 14, the user may select the condition of the opening time t3 in FIG. 14 having the thickness of the electrode 1 in the stop-rolling section Z2 thicker than that in FIG. 13.

As described with reference to FIG. 9 to FIG. 14, by using the prediction interface IF2, the user may arbitrarily input the opening gap G2 and the opening time t3, and may check the predicted thickness of the electrode 1 in the stop-rolling section Z2 by using the prediction model M. The user may determine the opening gap G2 and the opening time t3 that can achieve the desired thickness of the electrode 1 in the stop-rolling section Z2.

Then, the present disclosure will be described with reference to FIG. 8 again. In addition to displaying the graph C5, the prediction interface IF2 may display a result C4 (prediction result) indicating whether the thickness of the electrode 1 in the stop-rolling section Z2 is comprised within the production thickness range. The normal range refers to the production thickness range. When the thickness of the electrode 1 in the stop-rolling section Z2 is comprised within the production thickness range, “Pass” may be displayed in the result C4. Furthermore, when the thickness of the electrode 1 in the stop-rolling section Z2 is outside the production thickness range, “Fail” may be displayed in the result C4. That is, when a spec-out point (Spec-out) exists as shown in FIG. 9 or FIG. 12, “Fail” may be displayed in the result C4. As another display method, “O” and “X” may also be used to indicate the result C4. By checking the result C4, the user may quickly confirm whether the thickness of the electrode 1 in the stop-rolling section Z2 is comprised within the production thickness range within the allowable thickness range of the electrode 1 in the pre-stop rolling section Z1.

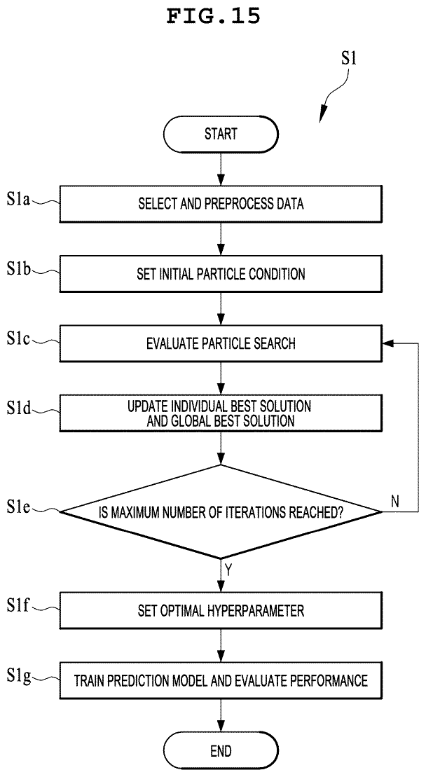

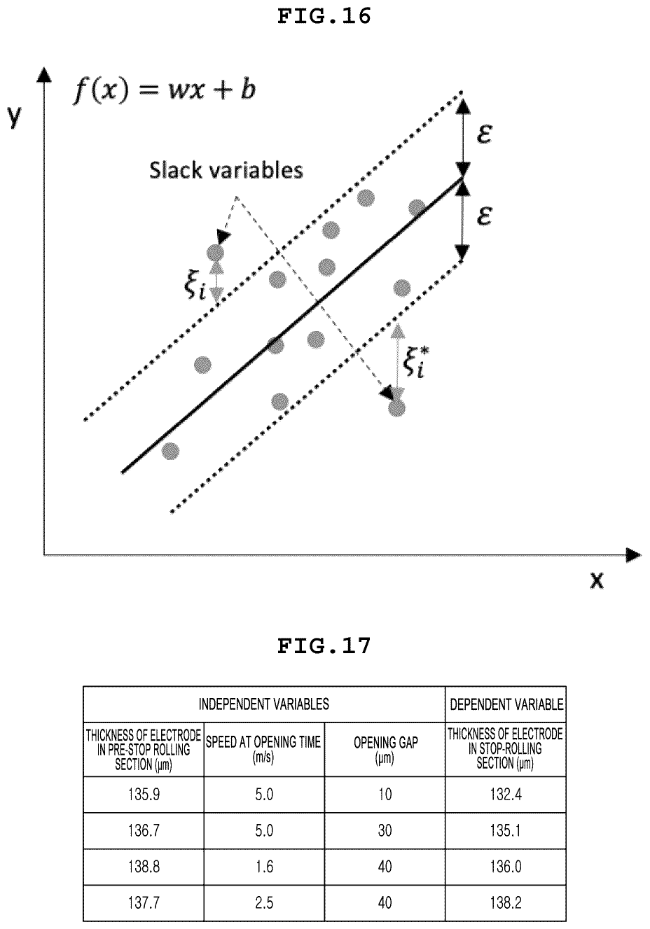

FIG. 15 is a flowchart illustrating a process S1 for generating the prediction model M according to an embodiment. FIG. 16 is a graph describing a support vector machine for generating the prediction model M according to an embodiment.

The prediction model M may be a trained model for predicting the thickness of the electrode 1 in the stop-rolling section Z2 by inputting the opening time t3 and the opening gap G2 input by the user. Various types of training models may be used in the prediction model M to predict the thickness of the electrode 1 in the stop-rolling section Z2. According to an embodiment, the prediction model M may use regression modeling. More specifically the prediction model M may use a Support Vector Regression (SVR) model generated by using a Support Vector Machine (SVM).

The Support Vector Regression (SVR) model, which is a regression model of the Support Vector Machine (SVM), finds a regression plane that predicts data on the basis of margin maximization. Unlike a general linear regression analysis model, the Support Vector Regression (SVR) model may perform nonlinear fitting using a Radial Basis Function (RBF) kernel and may achieve high generalization performance by allowing some noise through the setting of a slack variable.

In a data selection and preprocessing process Sla, input variables to be used for training are selected, and the data is preprocessed and prepared in a format suitable for training the model. Specifically, the thickness of the electrode 1 in the pre-stop rolling section Z1, the opening gap G2, and the opening time t3 may be selected as training data, and the thickness of the electrode 1 in the stop-rolling section Z2 may be selected as target data. As a preprocessing method, Min-Max Scaling may be applied.

An initial particle condition setting process S1b sets an initial particle set for Particle Swarm Optimization (PSO) which is an optimization algorithm. Each particle represents a hyperparameter combination (C, γ) of the Support Vector Regression (SVR) model, and an initial position and an initial velocity are randomly set. Specifically, the number of particles is set to 20, the maximum number of iterations is set to 50, an inertia coefficient w is set to 0.5, a cognitive coefficient c1 is set to 1.5, a social coefficient c2 is set to 1.5, a range of C is set to [0.1, 50], and a range of γ is set to [0.0001, 1].

In a particle search evaluation process S1c, the Support Vector Regression (SVR) model is trained according to a position of each particle, and an R2 value that is a target variable is calculated, thereby evaluating performance at the current position.

In an individual best solution and global best solution update process S1d, the performances of the particles are compared, and the individual best position of each particle and the global best position of all particles are updated. Through this, each particle reflects both own experience thereof and the experience of the swarm simultaneously.

A maximum iteration determination process S1e determines whether the preset maximum number of iterations has been reached. This is a process for determining whether the number of iterations of the processes of particle searching and best solution updating has reached the preset maximum number of iterations.

In an optimal hyperparameter setting process S1f, when the number of iterations reaches the preset maximum number (Y), the search is terminated, and the optimal hyperparameter values found up to that point are selected.

When the number of iterations does not reach the preset maximum number N, the particle search evaluation process S1c is performed again.

In a prediction model training and performance evaluation process S1g, the Support Vector Regression (SVR) model with the optimal C and γ values selected by the Particle Swarm Optimization (PSO) is trained, and the prediction performance of the model is evaluated by using R2 and RMSE, thereby checking the final performance.

The model generated through this process may be used to predict the thickness of the electrode 1 in the stop-rolling section Z2 in the thickness range of the electrode in the pre-stop rolling section Z1.

Equations 1 and 2 described below are mathematical equations defining the configuration of the Support Vector Regression (SVR) model.

$$min \frac{1}{2} {‖ w ‖}^{2} + C {\sum }_{} \text{?} ( {ξ}_{i}^{+} + {ξ}_{i}^{-} ) \qquad [ Equation 1 ]$$

$$\text{?} \text{indicates text missing or illegible when filed}$$

(w: a weight vector representing a gradient direction of a model and determining a prediction for a data point, C: a regularization parameter representing an error tolerance, n: the number of data samples, and ξ⁺ᵢ and ξ⁻ᵢ; slack variables for compensating errors when data points exist outside the tolerance)

$$\{ \begin{matrix}{y}_{i} - ( w \cdot {x}_{i} + b ) \leq ε + {ξ}_{i}^{+} \\ ( w \cdot {x}_{i} + b ) - {y}_{i} \leq ε + {ξ}_{i}^{-} \\ {ξ}_{i}^{+} , {ξ}_{i}^{-} \geq 0\end{matrix} \qquad [ Equation 2 ]$$

(yᵢ: a target value of the training data, w: a weight vector, xᵢ: an input value of the training data, b: a bias, and ε: a tolerance range)

In a Support Vector Regression (SVR) modeling process, the slack variables and the Radial Basis Function (RBF) kernel are defined by the hyperparameters C and γ (gamma), and optimization of the C and the γ is required to achieve high prediction performance. C may control the sensitivity to error and may set an allowable error level of the model. γ may adjust the influence range of the Radial Basis Function (RBF) kernel. Generally, large C and γ values may cause overfitting, and small C and γ values may cause underfitting.

In order to optimize the hyperparameters, the Particle Swarm Optimization (PSO) algorithm may be applied. The Particle Swarm Optimization (PSO) algorithm is a method in which particles forming a swarm search for an optimal solution, and each particle updates the position thereof by using the individual best solutions thereof and the global best solution. Equations 3 and 4 described below are equations constituting the Particle Swarm Optimization (PSO) algorithm.

$${v}_{i} ( t + 1 ) = w \cdot {v}_{i} ( t ) + {c}_{1} \cdot {r}_{1} \cdot ( {p}_{i} ( t ) - {x}_{i} ( t ) ) + {c}_{2} \cdot {r}_{2} \cdot ( g ( t ) - {x}_{i} ( t ) ) \qquad [ Equation 3 ]$$

(vi(t+1): a velocity of a particle i at a (t+1)th iteration, vi(t): a velocity of particle i at a (t)th iteration, w: an inertia weight adjusting a tendency to maintain a previous velocity and balancing a search and convergence speed, c1: a cognitive coefficient adjusting a tendency to follow the best position thereof, r1: a random value in [0, 1] adding randomness to a cognitive component, pi(t): a personal best position of the particle i, xi(t): a position of the particle i at the (t)th iteration, c2: a social coefficient adjusting a tendency to follow the global best position of the swarm, r2: a random value in [0, 1] adding randomness to a social component, and g(t): a global best position of the swarm)

$${x}_{i} ( t + 1 ) = {x}_{i} ( t ) + {v}_{i} ( t + 1 ) \qquad [ Equation 4 ]$$

(xi(t+1): an updated position of the particle i at the (t+1)th iteration, xi(t): a position of the particle i at the (t)th iteration, and vi(t+1): a velocity updated at the (t+1)th iteration)

The prediction model M is constructed by applying the Particle Swarm Optimization (PSO) algorithm and using the training data below. When C=10.307 and γ=0.407 is applied, it is confirmed that R2=0.815 and RMSE=0.760 is achieved.

FIG. 17 shows a portion of the training data used to generate the prediction model M.

The training data comprises the thickness of the electrode 1 in the pre-stop rolling section Z1, the speed at the opening time t3, and the opening gap G2 as independent variables, and comprises the thickness of the electrode 1 in the stop-rolling section Z2 as a dependent variable. The training data may be acquired by repeatedly performing an operation in which the rolling process performed, is temporarily stopped, and then resumed. In FIG. 17, the data contained in one row represents the thickness of the electrode 1 sensed by one of the plurality of sensors 51 of the sensing unit 50.

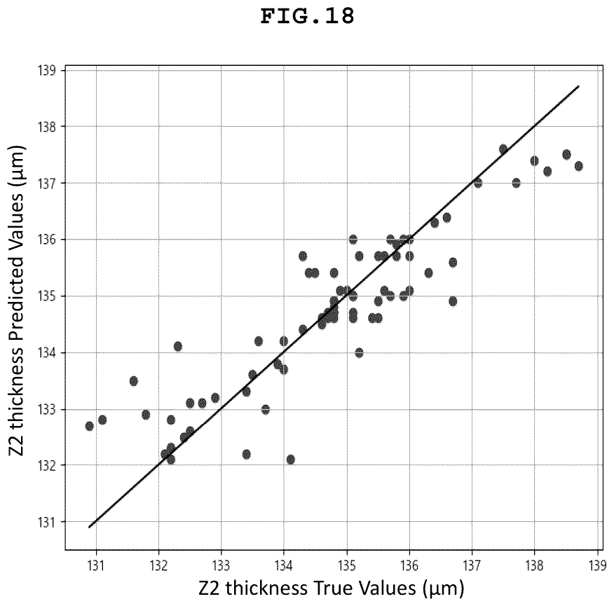

FIG. 18 is a graph illustrating the performance of the prediction model M according to an embodiment.

FIG. 18 shows the result of performing a plurality of predictions using the prediction model M generated by training the Support Vector Regression (SVR) model described with reference to FIG. 15, FIG. 16, and FIG. 17 using the training data. In the graph, the horizontal axis represents the true sensed thickness (True Values) of the electrode 1 in the stop-rolling section Z2, and the vertical axis represents the predicted thickness (Predicted Values) of the electrode 1 in the stop-rolling section Z2. Overall, it can be seen that the predicted values and the true values of the thickness of the electrode 1 in the stop-rolling section Z2 are distributed close to a line having a slope of 1. Therefore, the prediction values of the prediction model M can be considered reliable.

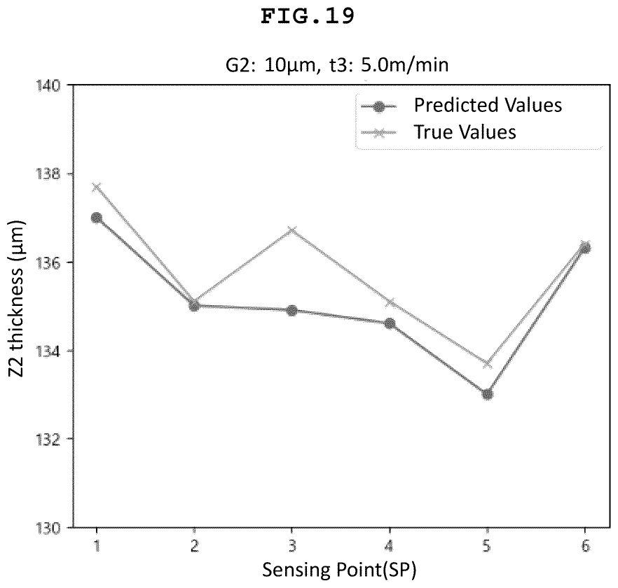

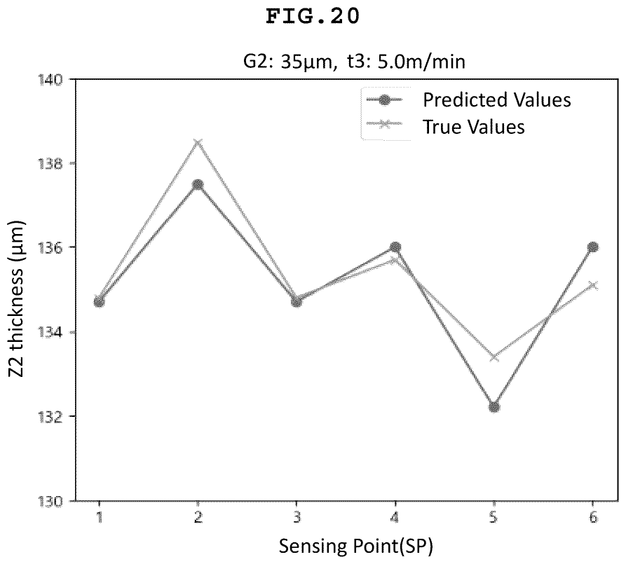

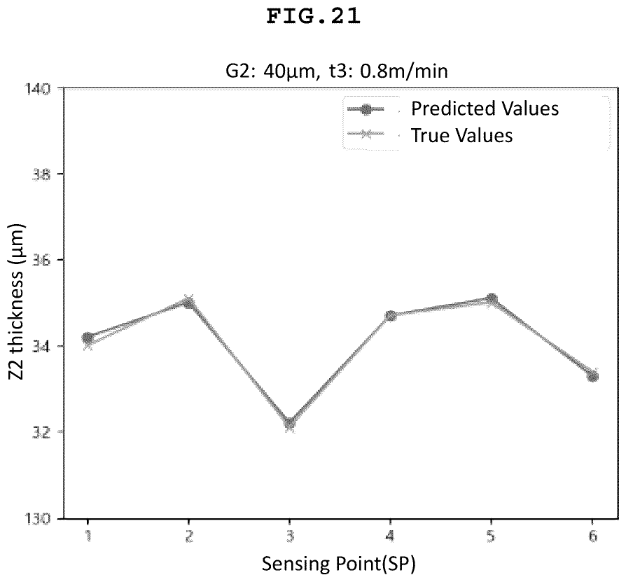

FIG. 19, FIG. 20, FIG. 21, and FIG. 22 are graphs comparing predicted values (Predicted Values) and true values (True Values) of the prediction model M according to an embodiment. In each graph, the horizontal axis represents sensing points of the plurality of sensors 51 comprised in the sensing unit 50. The vertical axis represents the thickness of the electrode 1 in the stop-rolling section Z2.

In FIG. 19, when the opening gap G2 is 10 μm and the opening time t3 is 5 m/min, the sensed values (True Values) and the predicted values (Predicted Values) may be checked at six sensing points SP of the sensing unit 50.

In FIG. 20, when the opening gap G2 is 35 μm and the opening time t3 is 5 m/min, the sensed values (True Values) and the predicted values (Predicted Values) may be checked at the six sensing points SP of the sensing unit 50.

In FIG. 21, when the opening gap G2 is 40 μm and the opening time t3 is 0.8 m/min, the sensed values (True Values) and the predicted values (Predicted Values) may be checked at the six sensing points SP of the sensing unit 50.

In FIG. 22, when the opening gap G2 is 40 μm and the opening time t3 is 2.5 m/min, the sensed values (True Values) and the predicted values (Predicted Values) may be checked at the six sensing points SP of the sensing unit 50.

Referring to FIG. 19 to FIG. 22, it can be seen that the difference between the sensed values (True Values) and the predicted values (Predicted Values) at each sensing point SP is within about 2 μm when the opening gap G2 is in the range of 10 μm to 40 μm and the opening time t3 is in the range of 0.8 m/min to 5 m/min. In addition, it can be seen that the overall graph shapes of the predicted values and the measured values are similar in each of FIG. 19 to FIG. 22. Therefore, it can be seen that the thickness of the electrode 1 in the stop-rolling section Z2 predicted by using the prediction model M is reliable.

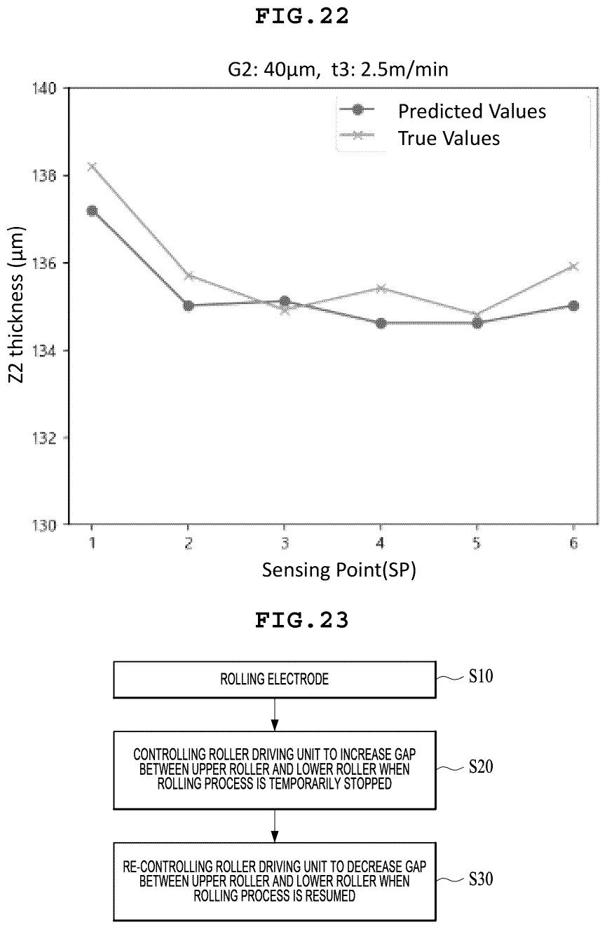

FIG. 23 is a flowchart illustrating each process of a control method of the electrode rolling apparatus 10 according to an embodiment.

According to an embodiment, the control method of the electrode rolling apparatus 10 may comprise rolling the electrode 1 by using the upper roller 21 and the lower roller 22 S10, and may comprise controlling the roller driving unit 30 operating the upper roller 21 and the lower roller 22 by using the controller 40 such that the gap between the upper roller 21 and the lower roller 22 is increased up to the opening gap G2 when the rolling of the electrode 1 S10 is temporarily stopped S20.

The rolling of the electrode 1 S10 is a process in which the rolling process is normally operated. In the rolling of the electrode 1 S10, the gap between the upper roller 21 and the lower roller 22 may be maintained at the production gap G1. The electrode 1 may be rolled while the electrode 1 passes between the upper roller 21 and the lower roller 22. The sensing unit 50 may sense the thickness of the rolled electrode 1, and may transmit the sensed thickness to the controller 40. The sensing unit 50 may measure the thickness of the electrode 1 at each sensing point SP where the sensor 51 is positioned. The electrode 1 may be moved at a predetermined moving speed.

The controlling of the roller driving unit 30 S20 may be performed when the rolling process is temporarily stopped. The controlling of the roller driving unit 30 S20 is a process of controlling the gap between the upper roller 21 and the lower roller 22 to be increased. The controller 40 may control the roller driving unit 30 such that the gap between the upper roller 21 and the lower roller 22 is increased to the opening gap G2. When the gap between the upper roller 21 and the lower roller 22 reaches the opening gap G2, the roller driving unit 30 may stop the operation of increasing the gap between the upper roller 21 and the lower roller 22.

In the controlling of the roller driving unit 30 S20, the controller 40 may control the roller driving unit 30 such that the upper roller 21 and the lower roller 22 are moved away from each other at a predetermined roller moving speed from the opening time t3 at which the moving speed of the electrode 1 reaches a predetermined speed. FIG. 6 will be referred to together with the following description.

In the controlling of the roller driving unit 30 S20, the controller 40 may control the roller driving unit 30 such that the upper roller 21 and the lower roller 22 are moved away from each other starting from the opening time t3. The opening time t3 may be a moment when the moving speed of the electrode 1 is gradually decreased from the production speed V1 and reaches a predetermined speed. For example, when the electrode 1 is moved at the production speed V1 (100 m/min), the rolling process is temporarily stopped, and then the moving speed of the electrode 1 is gradually decreased and reaches to a predetermined speed (5 m/min), the controller 40 may control the upper roller 21 and the lower roller 22 such that the upper roller 21 and the lower roller 22 are moved away from each other.

In the controlling of the roller driving unit 30 S20, the controller 40 may control the roller driving unit 30 such that the upper roller 21 and the lower roller 22 are moved away from each other according to the roller moving speed. The roller moving speed may be a value determined according to specifications of the rollers 20 and the roller driving unit 30, or may be a value input by the user.

When the controlling of the roller driving unit 30 S20 is performed, the gap between the upper roller 21 and the lower roller 22 becomes the opening gap G2, and the upper roller 21 and the lower roller 22 may press the electrode 1 in the stop-rolling section Z2 with a relatively small pressure. Therefore, over-rolling of the electrode 1 in the stop-rolling section Z2 may be prevented.

The control method of the electrode rolling apparatus 10 may further comprise re-controlling, by the controller 40, the roller driving unit 30 operating the upper roller 21 and the lower roller 22 such that the gap between the upper roller 21 and the lower roller 22 is decreased to the production gap G1 when the temporary stop of the rolling of the electrode 1 S10 is resolved.

The re-controlling of the roller driving unit 30 S30 is a process in which the cause of the temporary stop is released and the rolling process is resumed. In the re-controlling of the roller driving unit 30 S30, the controller 40 may control the roller driving unit 30 such that the upper roller 21 and the lower roller 22 are moved close to each other at the roller moving speed so that the gap between the upper roller 21 and the lower roller 22 becomes the production gap G1. When the re-controlling of the roller driving unit 30 S30 is performed, the gap between the upper roller 21 and the lower roller 22 are returned to the production gap G1, and the electrode 1 is capable of being rolled while the electrode 1 passes between the upper roller 21 and the lower roller 22.

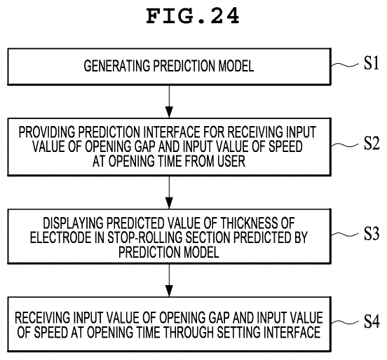

FIG. 24 is a flowchart illustrating processes for determining the opening gap G2 and a speed at the opening time t3 according to an embodiment.

In FIG. 24, generating the prediction model M S1, providing the prediction interface IF2 S2, displaying the predicted thickness of the electrode 1 in the stop-rolling section Z2 S3, and receiving the input values of the speed at the opening time t3 and the input value of the opening gap G2 through the setting interface IF1 S4 may be performed before the rolling of the electrode 1 S10.

The control method of the electrode rolling apparatus 10 may further comprise receiving, by the controller through the setting interface IF1, input values of the opening time t3 at which the upper roller 21 and the lower roller 22 start to be move away from each other and the opening gap G2 at which the upper roller 21 and the lower roller 22 are moved away from each other S4. FIG. 7 will be referred to together with the following description.

The receiving of the input values of the opening time t3 and of the opening gap G2 through the setting interface IF1 S4 may be performed before the rolling of the electrode 1 S10. This is because, when the process of rolling the electrode 1 is temporarily stopped, the speed at the opening time t3 and the opening gap G2 are required to be input in advance to perform the controlling of the roller driving unit 30 S20.

The controller 40 may display the setting interface IF1 capable of receiving the input values of the opening gap G2 and the speed at the opening time t3 on the display device of the input/output interface 43. The user may input values for the opening gap G2 and the speed at the opening time t3 through the setting interface IF1. The controller 40 may store the input values of the opening gap G2 and the speed at the opening time t3 input by the user, and may control the roller driving unit 30 in the controlling of the roller driving unit 30 S20 on the basis of the stored input values of the opening gap G2 and the speed at the opening time t3. The setting interface IF1 may also receive the input value of the roller moving speed. When the roller moving speed is controllable according to the roller driving unit 30, the input value of the roller moving speed may also be input through the setting interface IF1.

In order to input the opening gap G2 and the speed at the opening time t3 to the setting interface IF1, the user may check the predicted thickness of the electrode 1 in the stop-rolling section Z2 through the prediction interface IF2.

The control method of the electrode rolling apparatus 10 may further comprise the providing of the prediction interface IF2 predicting the thickness of the electrode 1 in the stop-rolling section Z2 when the opening gap G2 and the speed at the opening time t3 are input S2 and the inputting, by the controller 40, of the opening gap G2 and the opening time t3 input through the prediction interface IF2 to the prediction model M and then the displaying of the thickness of the electrode 1 in the stop-rolling section Z2 predicted by the prediction model M S3 by using the prediction model M that is generated by training, through the regression modeling method, training data collected while the rolling process is performed on the electrode 1 and then the rolling process is temporarily stopped. In the training data, the thickness of the electrode 1 in the pre-stop rolling section Z1, the opening gap G2, and the roller moving speed are used as independent variables and the thickness of the electrode 1 in the stop-rolling section Z2 is used as a dependent variable. FIG. 8 will be referred to together with the following description.

The providing of the prediction interface IF2 S2 and the displaying of the thickness of the electrode 1 in the stop-rolling section Z2 predicted by the prediction model M S3 may be performed before the receiving of the input value of the opening gap G2 and the input value of the speed at the opening time t3 through the setting interface IF1 S4.

In the providing of the prediction interface IF2, the controller 40 may display the prediction interface IF2 as illustrated in FIG. 8 to the display device of the input/output interface 43. The prediction interface IF2 may comprise the item C1 for selecting the prediction model, the item C2 for inputting the opening gap G2 and the speed at the opening time t3, the prediction button C3, the item C4 indicating whether the predicted thickness of the electrode 1 in the stop-rolling section Z2 is within the production thickness range, and the graph item C5 displaying the predicted thickness of the electrode 1 in the stop-rolling section Z2 and the thickness of the electrode 1 in the pre-stop rolling section Z1.

The user may select the prediction model M from the list provided in the prediction interface IF2, may input the opening gap G2 and the speed at the opening time t3, and then may select the prediction button C3.

In the displaying of predicted thickness of the electrode 1 in the stop-rolling section Z2 S3, the controller 40 may input the opening gap G2, the opening time t3 together with a determined roller moving speed to the prediction model M. The prediction model M may output a result of predicting the thickness of the electrode 1 in the stop-rolling section Z2. The controller 40 may display the predicted thickness of the electrode 1 in the stop-rolling section Z2 on the prediction interface IF2.

The displaying of the predicted thickness of the electrode 1 in the stop-rolling section Z2 S3 may further display the predicted thickness as a graph along the plurality of sensing points arranged in a width direction of the electrode 1, and may further display a determination result indicating whether the predicted thickness deviates from a normal range. As the controller 40 performs inputting the opening gap G2 and the speed at the opening time t3 input by the user to the prediction model M selected by the user, the controller 40 may display the predicted thickness of the electrode 1 in the stop-rolling section Z2 output by the prediction model M. The controller 40 may display “Pass” when the predicted thickness of the electrode 1 in the stop-rolling section Z2 is within the production thickness range, and may display “Fail” when the predicted thickness of the electrode 1 in the stop-rolling section Z2 is outside the production thickness range. The controller 40 may display a graph indicating the predicted thickness of the electrode 1 in the stop-rolling section Z2 and the thickness of the electrode 1 in the pre-stop rolling section Z1 together with lower and upper limits of the production thickness range. In the graph, the controller 40 may display predicted values within the production thickness range and predicted values outside the production thickness range in different shapes or different colors.

The generating of the prediction model M S1 may be performed for providing the prediction interface IF2 to the user. The process of generating the prediction model M is already described with reference to FIG. 15 and FIG. 16. The generating of the prediction model M S1 may be performed by the controller 40. The generating of the prediction model M S1 is a process of training the Support Vector Regression (SVR) model by using training data. As described with reference to FIG. 17, the training data may comprise the thickness of the electrode 1 in the pre-stop rolling section Z1, the speed at the opening time t3, and the opening gap G2 as independent variables, and may comprise the thickness of the electrode 1 in the stop-rolling section Z2 as a dependent variable. The training data may use existing data collected while the rolling process is performed. As described with reference to FIG. 16, the Support Vector Regression model may comprise a model configured by using equations 1 to 4.

The generating of the prediction model M S1 may be performed in a model generating device (not illustrated) independent of the controller 40. The model generating device may be a computing device. The model generating device may generate the prediction model M, and may transmit the trained prediction model M to the controller 40. The model generating device may provide the prediction interface IF2 by using the trained prediction model M. The model generating device may generate an execution program comprising the trained prediction model M and the prediction interface IF2. The user may run the execution program on various computing devices. The user may run the execution program, and may predict the thickness of the electrode 1 in the stop-rolling section Z2 by using the prediction interface IF2 using the prediction model M. The user may determine the appropriate opening gap G2 and the appropriate opening time t3 by using the prediction interface IF2 executed on the computing device other than the controller 40, and then may input the opening gap G2 and the opening time t3 to the input interface of the electrode rolling apparatus 10. Accordingly, the user may conveniently determine the opening gap G2 and the speed at the opening time t3 by using the execution program.

The user may input the opening gap G2 and the speed at the opening time t3 to the controller 40 through the input interface, and may perform the rolling process. When the rolling process is temporarily stopped, the controller 40 may prevent the over-rolling phenomenon of the electrode 1 by moving the upper roller 21 and the lower roller 22 up to the input opening gap G2 at the opening time t3.

The present disclosure has been described in detail through specific embodiments. The contents described above are only examples of applying the principles of the present disclosure, and other configurations may be further comprised within the scope of the present disclosure.

What is claimed is:

1. An electrode rolling apparatus comprising:
an upper roller;
a lower roller spaced apart from the upper roller by a predetermined distance;
a roller driving unit configured to rotate the upper roller and the lower roller and to adjust a gap between the upper roller and the lower roller; and
a controller configured to control the roller driving unit such that the gap between the upper roller and the lower roller is increased up to an opening gap when a rolling process in which an electrode moving in one direction is rolled by passing between the upper roller and the lower roller is temporarily stopped.

2. The electrode rolling apparatus of claim 1, wherein, when the rolling process is temporarily stopped, the controller is configured to control the roller driving unit such that the gap between the upper roller and the lower roller is increased from an opening time that is a time point at which a moving speed of the electrode is decreased to a predetermined speed.

3. The electrode rolling apparatus of claim 1, wherein, when the rolling process is temporarily stopped, the controller is configured to control the roller driving unit such that the gap between the upper roller and the lower roller is increased at a roller moving speed at which the upper roller and the lower roller are moved away from each other.

4. The electrode rolling apparatus of claim 1, wherein the controller is configured to control the roller driving unit so as to increase the gap between the upper roller and the lower roller by moving only one of the upper roller or the lower roller or by moving both the upper roller and the lower roller.

5. The electrode rolling apparatus of claim 1, wherein the controller is configured to provide a setting interface for receiving an input value of an opening time at which the upper roller and the lower roller start to be moved away from each other and the opening gap at which the upper roller and the lower roller are moved away from each other.

6. The electrode rolling apparatus of claim 5, wherein the controller is configured to provide a prediction interface configured to predict a thickness of the electrode in a stop-rolling section by using a prediction model when the opening gap and the opening time are input to the prediction interface, the prediction model being generated by training, through a regression modeling method, training data collected while the rolling process is performed on the electrode and then the rolling process is temporarily stopped, in which the training data uses a thickness of the electrode in a pre-stop rolling section, the opening gap, and the opening time as independent variables and uses the thickness of the electrode in the stop-rolling section as a dependent variable.

7. The electrode rolling apparatus of claim 6, wherein, when the opening gap and the opening time are input and a prediction button is selected through the prediction interface, the prediction interface is configured to display a graph indicating whether a predicted thickness of the electrode in the stop-rolling section is outside a normal range for each predetermined candidate value comprised in an allowable range of the thickness of the electrode in the pre-stop rolling section.

8. A control method of an electrode rolling apparatus, the control method comprising:
rolling an electrode by using an upper roller and a lower roller; and
controlling, by a controller, a roller driving unit configured to operate the upper roller and the lower roller such that a gap between the upper roller and the lower roller is increased up to an opening gap when the rolling of the electrode is temporarily stopped.

9. The control method of claim 8, further comprising:
re-controlling, by the controller, the roller driving unit operating the upper roller and the lower roller such that the gap between the upper roller and the lower roller is decreased up to a production gap when the temporary stop of the rolling of the electrode is released.

10. The control method of claim 8, wherein, in the controlling of the roller driving unit, the controller controls the roller driving unit such that the upper roller and the lower roller are moved away from each other at a predetermined roller moving speed from an opening time at which a moving speed of the electrode reaches a predetermined speed.

11. The control method of claim 8, further comprising:
receiving, by the controller through a setting interface, input values of an opening time at which the upper roller and the lower roller start to be moved away from each other and the opening gap at which the upper roller and the lower roller are moved away from each other.

12. The control method of claim 11, further comprising:
providing, by the controller, a prediction interface configured to predict a thickness of the electrode in a stop-rolling section by using a prediction model when the opening gap and a speed at the opening time are input to the prediction interface, the prediction model being generated by training, through a regression modeling method, training data collected while the rolling of the electrode is performed and then the rolling of the electrode is temporarily stopped, in which the training data uses a thickness of the electrode in a pre-stop rolling section, the opening gap, and a roller moving speed as independent variables and uses the thickness of the electrode in the stop-rolling section as a dependent variable; and
inputting, by the controller, the opening gap and the opening time that are input through the prediction interface to the prediction model and displaying the thickness of the electrode in the stop-rolling section predicted by the prediction model.

13. The control method of claim 12, wherein, in the displaying of the predicted thickness of the electrode in the stop-rolling section, the predicted thickness of the electrode in the stop-rolling section is further displayed as a graph for a plurality of sensing points arranged along a width direction of the electrode, and a determination result indicating whether the predicted thickness of the electrode in the stop-rolling section deviates from a normal range is further displayed.
